(19) United States
(12) Patent Application Publication
(10) Pub. No.: US 2004/0229079 A1
(43) Pub. Date: Nov. 18, 2004

(54) Composite cookware having decorative outer surface and improved induction heating characteristics

(76) Inventor: William A. Groll, McMurray, PA (US)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(21) Appl. No.: 10/607,854

(22) Filed: Jun. 27, 2003

Related U.S. Application Data
(60) Provisional application No. 60/412,323, filed on Sep. 19, 2002.
(60) Provisional application No. 60/392,508, filed on Jun. 28, 2002.

(51) Int. Cl. A47J 27/00

(52) U.S. Cl. 428/653; 220/573.2

(57) ABSTRACT

Induction cookware made from a composite metal sheet comprising a layer of a ferromagnetic material and an outer decorative metal layer of copper, anodized, brushed or polished aluminum, or the like. The decorative outer layer has a thickness at least on the bottom wall thereof of between 0.0002 to 0.003 inch.

### CROSS REFERENCE TO RELATED APPLICATION

This application claims priority on U.S. Provisional Patent Application No. 60/412,323 filed Sep. 19, 2002, which, in turn, is a continuation-in-part of United States Provisional Patent Application No. 60/392,508, filed Jun. 28, 2002, entitled “Composite Cookware Having Decorative Outer Surface and Improved Induction Heating Characteristics” which is incorporated by reference herein. Priority under 35 U.S.C. §120 is claimed for all commonly disclosed subject matter.

### BACKGROUND OF THE INVENTION

1. Field of the Invention

The present invention relates generally to multilayer composite cookware and, more particularly, to multilayer composite cookware suitable for induction cooking wherein the outermost layer is a decorative metal in wrought form such as, for example, copper or aluminum.

2. Description of Related Art

The manufacture of multilayer composite cookware for induction cooking is well known in the art, as evidenced by U.S. Pat. No. 4,646,935 to Ulam and U.S. Pat. No. 3,966,426 to McCoy et al. It is also well known in the art to apply a roll bonded sheet of copper to the outside of multilayer composite cookware for a decorative appearance and to improve the thermal conductivity of cookware. Further, it is known that a layer of copper will shield an underlying layer of ferromagnetic material from the effects of an induction coil and prevent the ferromagnetic material from heating by induction. Accordingly, attempts to make multilayer composite induction cookware with a decorative outer surface layer of copper have heretofore been unsuccessful, notwithstanding the long-felt need for such a combination in the cookware art.

### SUMMARY OF THE INVENTION

Briefly stated, the present invention is directed to induction cookware having a decorative outer layer of a wrought metal, i.e., a roll bonded metal layer as opposed to a plated layer of metal. The decorative outer metal layer not only improves the cosmetic appearance but also enhances the induction heating characteristics of the cookware. The cookware is preferably made from a composite metal sheet comprising a layer of a high heat conducting material such as aluminum or copper bonded to a ferromagnetic layer for induction heating, such as a carbon steel, a ferritic stainless steel (preferably of the 400 series), or a NiFe material having a specific Curie temperature range. An outer decorative layer such as copper or aluminum of a critical bottom wall thickness, preferably between about 0.0002 and 0.003 inch and, more preferably, between 0.0005 and 0.002 inch, is bonded to the ferromagnetic layer. As alluded to above, the bonded decorative layer is in wrought form, such as a foil or sheet prior to bonding, preferably by pressure rolling, to the ferromagnetic layer. A decorative outer layer in wrought form provides wear resistance to the decorative outer layer. A decorative outer layer of aluminum may be finished as a brushed or polished aluminum surface or as an anodized aluminum surface while a decorative outer layer of copper may be finished as a brushed or polished copper surface, as desired.

### BRIEF DESCRIPTION OF THE DRAWINGS

FIG. 1 is an enlarged, fragmented, cross-sectional schematic view of one presently preferred composite material suitable for making induction cookware according to the present invention;

FIGS. 2-4 are schematic views similar to FIG. 1, depicting additional presently preferred embodiments of the present invention; and

FIG. 5 is a graph plotting the thickness of the decorative layer vs. time to bring water to a full boil in an induction heating comparative experiment.

### DETAILED DESCRIPTION OF THE INVENTION

As previously discussed above, it has long been sought in the art to provide induction cookware with a decorative outer surface. Prior attempts to apply a decorative outer layer of copper by plating to induction cookware have not been satisfactory because the plated layer does not adhere well to the ferromagnetic layer and is easily abraded or scratched and/or worn off by repeated cleaning and polishing. Attempts to use a wrought, bonded layer of copper have also proved fruitless because the wrought copper layer, even in very thin gauges of 0.003 inch, for example, was found to effectively shield the ferromagnetic layer and prevented it from heating when subjected to the field of an induction heating coil. Initially, it was determined that efficient induction heating could only be achieved if the wrought copper decorative layer were completely removed from the bottom of the finished cookware by grinding to expose the ferromagnetic layer to the effects of the induction coil.

Complete removal of the copper layer from the bottom wall of the cookware, of course, detracts from the cosmetic appearance of the utensil. I, therefore, conducted an additional investigation to determine if some very thin (<0.003 inch) layer of copper could be left at the bottom after grinding the originally bonded sheet, wherein the ground layer would still produce adequate induction heating in the ferromagnetic layer while maintaining the enhanced cosmetic appearance of copper.

In the course of my above investigation, I discovered a totally surprising and unexpected result. I determined that over a very small, critical range of thicknesses, the outer decorative layer of copper on the bottom wall actually improved the induction heating response of the ferromagnetic layer when compared with the bare ferromagnetic layer.

More particularly, my experimental work demonstrated that when the thickness of the outer decorative layer on the bottom wall is controlled between about 0.0002 to 0.003 inch and, more preferably, between 0.0005 to 0.002 inch, the induction heating response of the ferromagnetic layer is increased over that of a bare (uncoated) ferromagnetic layer. This unexpected result was found when using a decorative outer layer of copper and also with aluminum (brushed or polished) as well as with a layer of anodized aluminum on the decorative surface.

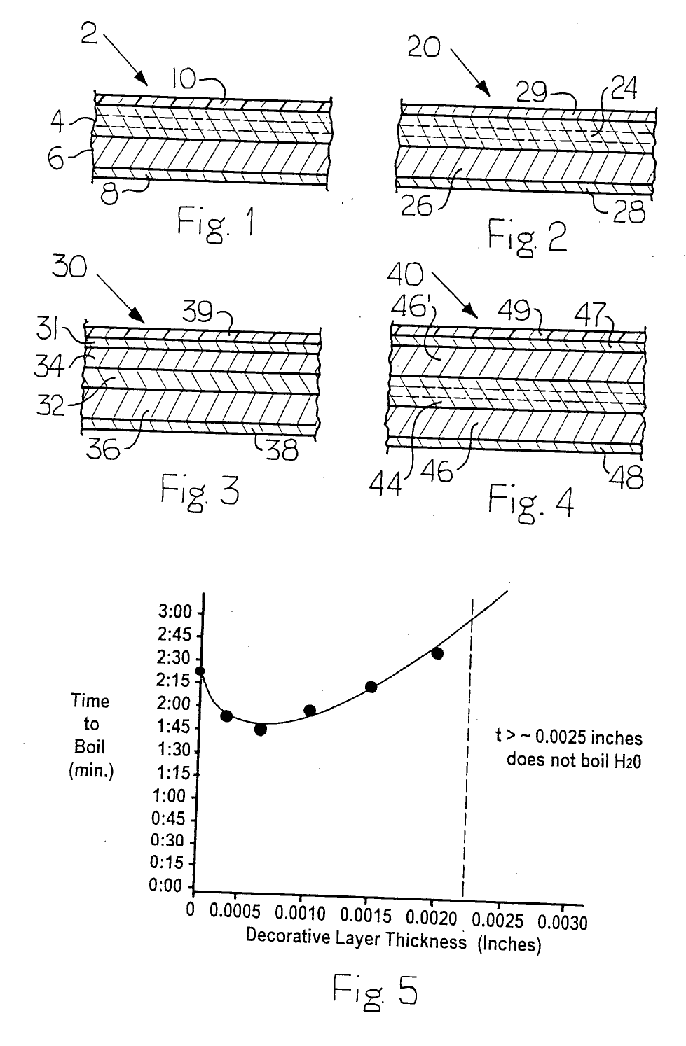

I have conceived and developed a number of presently preferred embodiments of the present invention for use in composite induction cookware. FIGS. 1 through 4 depict several of these presently preferred embodiments; however, it will be understood that my invention is not limited to the particular embodiments shown and described herein but, rather, my invention encompasses the broad concept of applying a decorative outer layer of a metal such as copper, aluminum (bare or anodized) or some like decorative metal, in a critical thickness at the bottom wall of the vessel to enhance the induction heating characteristics of the ferromagnetic layer in the cookware.

FIG. 1 depicts a composite metal sheet 2 suitable for the manufacture of induction cookware of the present invention. Composite metal sheet 2 comprises a high heat conductive layer 4 of Alclad aluminum material bonded to a ferromagnetic layer 6 of a ferritic grade of stainless steel, such as 409 or 436 type stainless steel. Alclad aluminum, in and of itself, is well-known and consists of three prebonded layers, with a core of a higher strength aluminum alloy, such as a 3000 series alloy, sandwiched between thinner layers of substantially pure or “E.C.” grade aluminum. The Alclad layer bonds well to stainless steel by virtue of the high purity aluminum layer. The composite metal sheet 2 of FIG. 1 also includes outer decorative layer 8 of a metal such as copper or aluminum bonded to the ferromagnetic layer 6 and also preferably includes a non-stick layer 10 of a PTFE material, ZrN or like material, on the food contacting cook surface of the cookware or bakeware (herein referred to collectively merely as “cookware”). If the decorative layer 10 is aluminum, it is preferably anodized by a known type II anodizing process conducted at subzero temperatures.

The metal layers 4, 6 and 8 are intimately bonded together, preferably by a roll bonding process, which in itself is well-known in the art. The roll bonded composite comprising metal layers 4, 6 and 8 is also preferably heat treated by known techniques to provide diffusion bonding across the metal interfaces so as to increase the bond strength and thermal transfer across the metal interfaces of the several layers. The so-bonded composite is then formed into a desired cookware shape or configuration, as by deep drawing or like process, also in itself well-known in the art. The non-stick surface 10 is typically applied as a final step in the manufacturing process.

FIG. 2 depicts a further composite metal sheet 20 in a cookware utensil which is similar to that described above in connection with FIG. 1. Composite sheet 20 includes a heat conductive layer 24 of Aldlad aluminum bonded to a ferromagnetic layer 26 preferably of ferritic grade stainless steel and a decorative outer layer 28 of copper or aluminum bonded thereto. In place of non-stick PTFE surface 10 of composite sheet 2, the composite metal sheet 20 of FIG. 2 includes a layer 29 of austenitic stainless steel, preferably type 304 stainless steel bonded to the aluminum heat conductive layer 24. The austenitic stainless steel layer 29 provides an excellent cook surface, one which is preferred by many professional cooks due to its excellent wear and stick resistant properties.

A still further presently preferred embodiment of my invention is shown in FIG. 3 which finds practical application as cookware in an induction heated rice cooker. The composite metal sheet 30 depicted in FIG. 3 may be finish formed into a bowl-like shape (not shown) for use in self-contained induction powered rice cookers, the configurations of which are well-known in the art. Composite metal sheet 30 includes a heat conductive layer 34 of copper with layers 31 and 32 of aluminum bonded on each face thereof. A ferromagnetic layer 36, preferably of ferritic stainless steel such as type 436, is bonded to the lower aluminum layer 32. A decorative layer 38 of copper or aluminum is bonded to the ferromagnetic layer 36. Finally, a non-stick surface 39 preferably of PTFE or a like non-stick material is applied to the upper aluminum layer 31 to define the interior, food contacting cook surface of the rice cooker made from the composite sheet 30. If aluminum is selected as the decorative layer 38, it may be anodized prior to applying the PTFE non-stick surface 39.

A still further variation of my invention is embodied in composite metal sheet 40 shown in FIG. 4. Composite metal sheet 40 includes a heat conductive layer 44 of Aldlad aluminum which is bonded on each face to layers 46 and 46′ of a ferritic grade of stainless steel, preferably type 436. A decorative outer layer 48 of aluminum is bonded to the stainless steel layer 46 and a layer 47 of aluminum is bonded to the layer 46′ of stainless steel. It will be appreciated that the layers 46 and 48 form mirror images of layers 46′ and 47, respectively, on either side of the heat conductive layer 44. Such symmetry in the layers improves the thermal expansion characteristic of the composite metal sheet 40 and allows for more uniform thermal expansion in the composite during service so as to reduce possible warping, particularly in flat cookware configurations. A non-stick layer 49 is finally applied to the upper aluminum layer 47 to provide a non-stick food contacting surface in the composite 40.

In all of the above-described embodiments, it is of utmost importance that the thickness of the decorative outer layers 8, 28, 38 and 48 at the bottom of the cookware (or in any area adjacent to the inductor coil) be controlled within a critical range of between about 0.0002 to 0.003 inch and, more preferably, between 0.0005 to 0.002 inch in order to achieve the enhanced cosmetic and induction heating properties. In the aforementioned rice cooker, the sides of the bowl-shaped vessel also are intended to be induction heated and, accordingly, the thickness of the decorative outer layer along the bottom wall as well as the sidewall is controlled within the critical thickness range.

FIG. 5 graphically depicts the range of thickness of the decorative outer layer at the bottom (or sidewall) of the cookware necessary to achieve the enhanced induction heating property. The data reported in FIG. 5 show that very small thicknesses of a decorative layer of copper or aluminum (bare or anodized) starting at about 0.0002 in thickness up to about 0.0025 inch increases the heating efficiency of the induction cookware. The data set forth in FIG. 5 show that induction cookware having a decorative coating thickness within the above-described range required less time to bring water to a full boil than an uncoated, bare ferritic stainless steel bottomed vessel, previously thought to be the benchmark as the best induction surface.

The critical thickness in the decorative layers 8, 28, 38 and 48 of FIGS. 1-4, respectively, can be achieved by using thin gauge starting materials, such as with aluminum foil, or it can be accomplished by using heavier starting thicknesses followed by rolling and/or mechanical grinding/abrading to achieve the desired 0.0002 to 0.003 inch thickness range.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof.

I claim:

1. Induction cookware having a decorative outer surface made from a composite metal sheet comprising at least one layer of a ferromagnetic material and a layer of a decorative wrought metal bonded to the ferromagnetic layer and forming the outer surface of the cookware, said decorative layer having a thickness between about 0.0002 to 0.003 inch thick at least along a bottom wall of the cookware.

2. The induction cookware of claim 1 wherein the decorative outer layer is copper.

3. The induction cookware of claim 1 wherein the decorative outer layer is aluminum.

4. The induction cookware of claim 3 wherein the aluminum is anodized.

5. An induction heated rice cooker utensil comprising a bowl-shaped vessel made from a roll bonded composite composite metal sheet having one or more layers of a high heat-conducting metal of aluminum and/or copper bonded to a layer of a ferromagnetic material, and an outer decorative layer of copper bonded to the ferromagnetic material having a thickness at least along a bottom wall of between 0.0002 to 0.003 inch.

6. The rice cooker of claim 5 wherein the bowl-shaped vessel includes a non-stick surface applied to a food contacting side of the high heat-conducting metal layer.

7. The rice cooker of claim 6 wherein the bowl-shaped vessel includes a non-stick surface applied to a food contacting side of the high heat-conducting metal layer.

8. An induction heated rice cooker utensil comprising a bowl-shaped vessel made from a roll bonded composite metal sheet having one or more layers of a high heat-conducting metal of aluminum and/or copper bonded to a layer of a ferromagnetic material, and an outer decorative layer of anodized aluminum bonded to the ferromagnetic material having a thickness at least along a bottom wall of between 0.0002 to 0.003 inch.
